(19) United States
(12) Patent Application Publication
(10) Pub. No.: US 2016/0179210 A1
(43) Pub. Date: Jun. 23, 2016

(54) INPUT SUPPORTING METHOD AND INPUT SUPPORTING DEVICE

(71) Applicant: FUJITSU LIMITED, Kawasaki-shi (JP)

(72) Inventors: Katsushi SAKAI, Zama (JP); Yuichi MURASE, Yokohama (JP)

(21) Appl. No.: 14/971,245

(22) Filed: Dec. 16, 2015

(30) Foreign Application Priority Data
Dec. 19, 2014 (JP) 2014-258102

(51) Int. Cl. G06F 3/01; G02B 27/01; G06K 9/18

(52) U.S. Cl. CPC G06F 3/017; G06F 3/014; G06K 9/186; G02B 27/0179; G02B 27/0172; G02B 2027/0187; G02B 2027/014

(57) ABSTRACT

An input detection unit detects a motion of a finger on which a wearable device is worn. An axis detection unit detects an axis representing the posture of the finger on the basis of the detected motion of the finger. A display control unit displays a virtual laser printer that moves in association with the detected axis and the trace of the axis on a head-mounted display.

### CROSS-REFERENCE TO RELATED APPLICATION

This application is based upon and claims the benefit of priority of the prior Japanese Patent Application No. 2014-258102, filed on Dec. 19, 2014, the entire contents of which are incorporated herein by reference.

### FIELD

The embodiments discussed herein are related to an input supporting method, an input supporting program, and an input supporting device.

### BACKGROUND

In recent years, wearable devices have been used for work support. Because a wearable device is worn when used, for example, it is not possible to make input by, for example, touching a screen of a smartphone, or the like, and thus it is difficult to make operational input. For this reason, there is a technology for making input by gesture. For example, motions of a finger are detected by a wearable device that is worn on the finger to make input of handwritten characters.

Patent Document 1: Japanese Laid-open Patent Publication No. 2006-53909

Patent Document 3: Japanese Laid-open Patent Publication No. 2002-318662

Patent Document 3: Japanese Laid-open Patent Publication No. 2001-236174

With the conventional technology, however, it may be difficult to make input by a finger. A motion detected by the wearable device worn on the finger contains translational components and rotation components. Rotation components are detected depending on a variation in the posture of the finger, such as bending and stretching of the finger. Translational components are detected depending on translational movement, such as parallel movement, of the hand in the leftward/rightward direction and a lot of components from movement of the whole body are contained in the translational components. For this reason, as for translational components, it is difficult to detect only motions of the finger. Accordingly, a detected motion may differ from that intended by the user and accordingly it may be difficult to make input by using the finger.

### SUMMARY

According to an aspect of an embodiment, an input supporting method includes detecting, using a processor, a motion of a finger on which a wearable device is worn: detecting, using a processor, an axis representing a posture of the finger on the basis of the detected motion of the finger; and displaying, using a processor, a virtual laser pointer that moves in association with the detected axis and a trace of the axis on a head-mounted display.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram explaining an exemplary system configuration of an input system;

FIG. 2A is a diagram depicting an exemplary wearable device;

FIG. 2B is a diagram depicting the exemplary wearable device;

FIG. 2C is a diagram depicting the exemplary wearable device;

FIG. 2D is a diagram illustrating an exemplary operation on a switch of the wearable device;

FIG. 3 is a diagram illustrating an exemplary head-mounted display;

FIG. 4 is a diagram illustrating an exemplary device configuration;

FIG. 5 is a diagram illustrating exemplary rotation axes of a finger;

FIG. 6 is a diagram depicting an exemplary menu screen;

FIG. 7 is a diagram explaining a reference direction of a finger motion;

FIG. 8 is a diagram illustrating variations in the rotation speed in a state where the wearable device is normally worn;

FIG. 9 is a diagram illustrating a variation in the rotation speed in a state where the wearable device is obliquely shifted and worn;

FIG. 10 is a diagram illustrating an exemplary virtual laser pointer to be displayed;

FIG. 11 is a diagram illustrating an exemplary feedback to a user;

FIG. 12 is a diagram illustrating exemplary determination of a gesture;

FIG. 13A is a diagram illustrating exemplary results of display of traces of characters that are input by handwriting;

FIG. 13B is a diagram illustrating exemplary results of display of traces of characters that are input by handwriting;

FIG. 13C is a diagram illustrating exemplary results of display of traces of characters that are input by handwriting;

FIG. 13D is a diagram illustrating exemplary results of display of traces of characters that are input by handwriting;

FIG. 13E is a diagram illustrating exemplary results of display of traces of characters that are input by handwriting;

FIG. 13F is a diagram illustrating exemplary results of display of traces of characters that are input by handwriting;

FIG. 13G is a diagram illustrating exemplary results of display of traces of characters that are input by handwriting;

FIG. 14A is a diagram illustrating exemplary results of character recognition;

FIG. 14B is a diagram illustrating exemplary results of character recognition;

FIG. 14C is a diagram illustrating exemplary results of character recognition;

FIG. 14D is a diagram illustrating exemplary results of character recognition;

FIG. 15 is a diagram illustrating an exemplary result of display of a trace corresponding to a hook of a character;

FIG. 16 is a diagram illustrating an exemplary display of saved contents of memo information;

FIG. 17 is a flowchart illustrating an exemplary procedure of a menu process;

FIG. 18 is a flowchart illustrating an exemplary procedure of a calibration process;

FIG. 19 is a flowchart illustrating an exemplary procedure of a memo inputting process;

FIG. 20 is a flowchart illustrating an exemplary procedure of a memo browning process;

FIG. 21 is a flowchart of an exemplary procedure of an operation command outputting process;

FIG. 22 is a diagram illustrating exemplary correction on a trace;

FIG. 23 is a diagram illustrating exemplary correction on a trace;

FIG. 24 is a diagram illustrating exemplary correction on a trace; and

FIG. 25 is a diagram illustrating a computer that executes an input supporting program.

### DESCRIPTION OF EMBODIMENTS

Preferred embodiments of the present invention will be explained with reference to accompanying drawings. The embodiments do not limit the invention. Each embodiment may be combined as long as the process contents keep consistency.

### [a] First Embodiment

### System Configuration

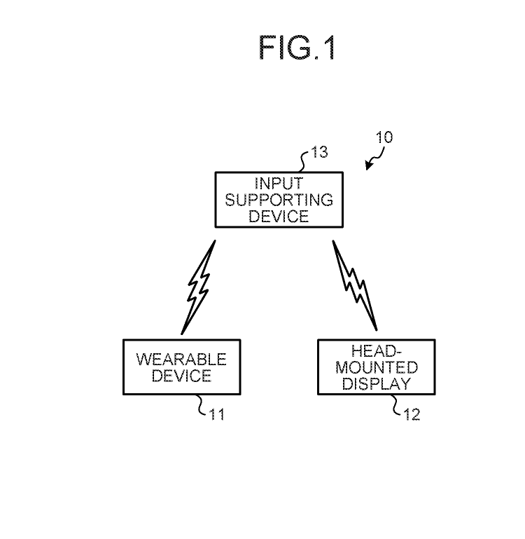

First, an exemplary input system that makes input by using an input supporting device according to a first embodiment will be explained. FIG. 1 is a diagram explaining an exemplary system configuration of an input system. As illustrated in FIG. 1, an input system 10 includes a wearable device 11, a head-mounted display 12, and an input supporting device 13. The wearable device 11, the head-mounted display 12, and the input supporting device 13 are communicably connected via a network and thus are capable of exchanging various types of information. As a mode of the network, regardless of whether it is wired or wireless, it is possible to use an arbitrary type of communication network, such as mobile communications using, for example, a mobile phone, the Internet, a local area network (LAN), or a virtual private network (VPN). For the first embodiment, a case will be explained where the wearable device 11, the head-mounted display 12, and the input supporting device 13 communicate by wireless communications.

The input system 10 is a system that supports a user to make input. For example, the input system 10 is used to support works of users in, for example, a factory, and the input system 10 is used when, for example, a user inputs a memo, or the like, by gesture. A user may work while moving between various locations. For this reason, enabling input by gesture by using not a fixed terminal, such as a personal computer, but the wearable device 11, allows the user to make input while moving between various locations.

The wearable device 11 is a device that is worn and used by a user and that detects gestures of the user. According to the first embodiment, the wearable device 11 is a device that is worn on a finger. The wearable device 11 detects a variation in the posture of the finger as a gesture of the user and transmits information on the variation on the posture of the finger to the input supporting device 13.

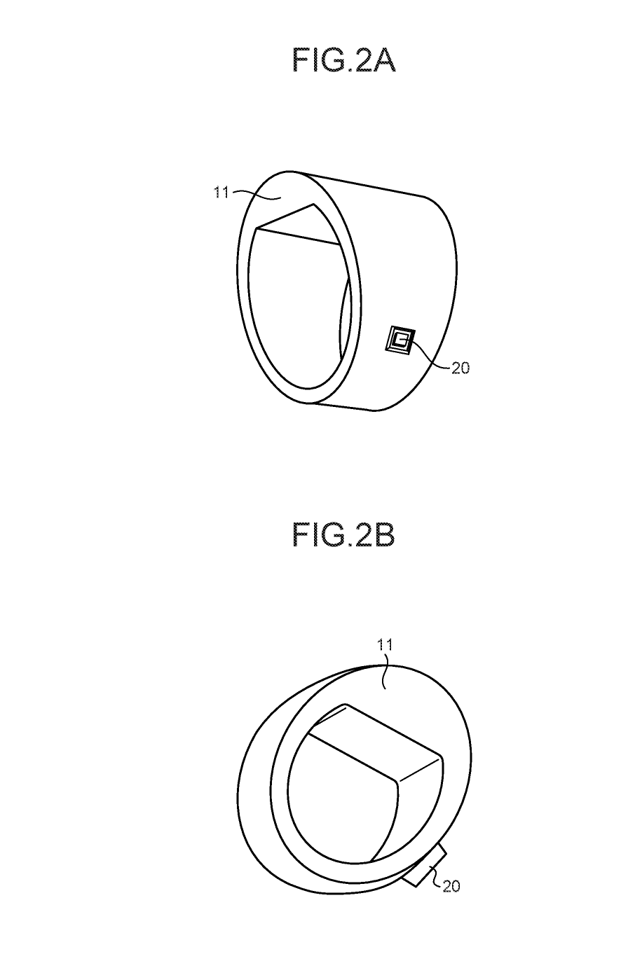

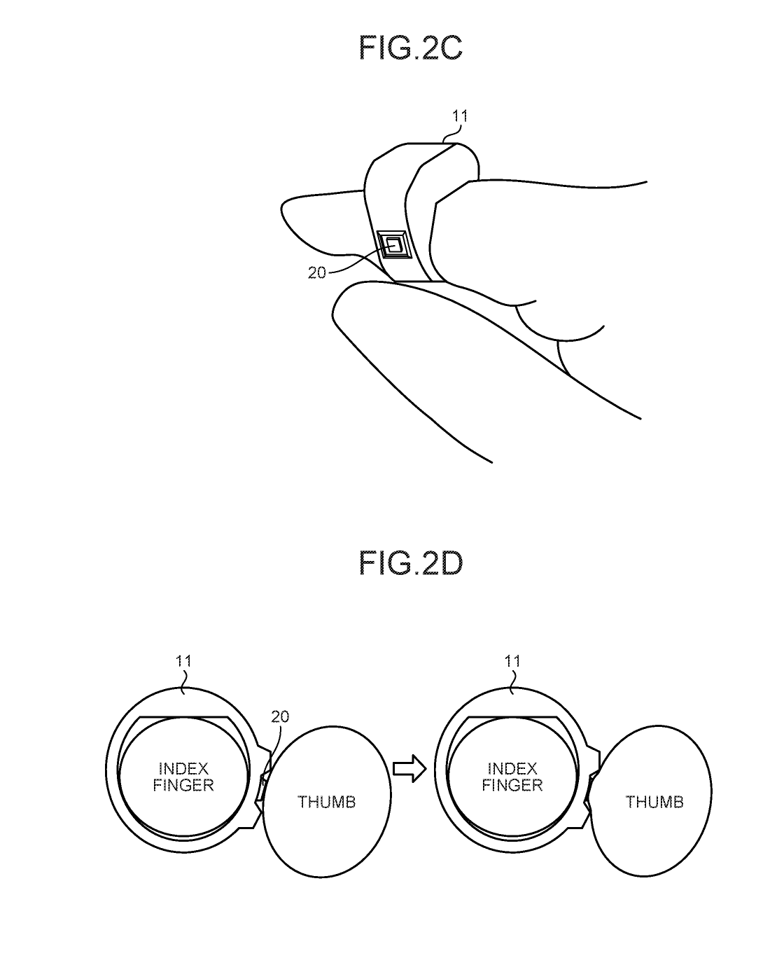

FIGS. 2A to 2C are diagrams depicting an exemplary wearable device. The wearable device 11 is ring-shaped like a ring. As depicted in FIG. 2C, by putting a finger through the ring, it is possible to wear the wearable device 11 on the finger. The wearable device 11 is formed such that a part of the ring is thicker and wider than other parts and that part serves as a parts-incorporating unit that incorporates main electronic parts. Furthermore, the wearable device 11 has a shape that easily fits the finger when the parts-incorporating unit is at the upper side of the finger. As depicted in FIG. 2C, the wearable device 11 is worn on the finger with the parts-incorporating unit on the upper side of the finger approximately in the same direction as that of the finger. As depicted in FIG. 2A, the wearable device 11 is provided with a switch 20 on a side surface of the ring. As depicted in FIG. 2C, the switch 20 is arranged at a position corresponding to the thumb when the wearable device 11 is worn on the index finger of the right hand. A part of the wearable device 11 around the switch 20 is formed to have a shape rising to the same height as that of the upper surface of the switch 20. Accordingly, the switch 20 of the wearable device 11 is not turned on when the finger is only put on the switch 20. FIG. 2D is a diagram illustrating an exemplary operation on the switch of the wearable device. The example illustrated in FIG. 2D represents the case where the wearable device 11 is worn on the index finger and the switch 20 is operated by the thumb. The wearable device 11 is not turned on when the thumb is only put on the switch 20 as illustrated on the left in FIG. 2D and the switch 20 is turned on by pressing the thumb as illustrated on the right in FIG. 2D. When starting input, the user puts the finger at an input position and presses in the finger to start making input. The switch 20 enters an on-state when it contracts and enters an off-state when it expands, and a force is applied to the switch 20 by an incorporated elastic member, such as a spring such that it keeps the expansion. Accordingly, the switch 20 enters the on-state when being pressed into by the finger and enters the off-state when being released because the finger eases the tension. Such a configuration disables the wearable device 11 to start making input when not worn in a normal state and, when the wearable device 11 is worn on a finger, the position at which the wearable device 11 is worn is naturally corrected to the position of the normal state. Furthermore, it is possible for the user to control input and non-input intervals without separating the finger from the switch 20.

FIG. 1 will be referred back. The head-mounted display 12 is a device that is worn by the user on the user's head and displays various types of information to be viewable by the user. The head-mounted display 12 may corresponds both of the eyes or corresponds to only one of the eyes.

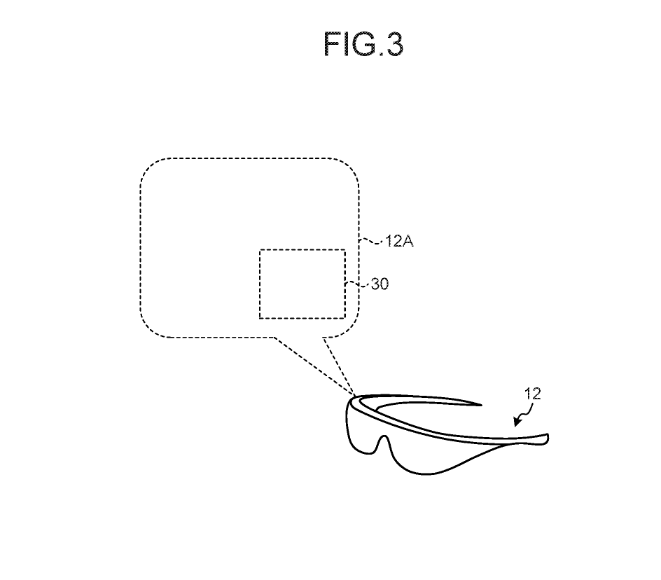

FIG. 3 is a diagram illustrating the exemplary head-mounted display. According to the first embodiment, the head-mounted display 12 has a shape of glasses corresponding to both of the eyes. The head-mounted display 12 has transparency at the lens part such that the user can view the real external environment even while wearing the head-mounted display 12. The head-mounted display 12 incorporates a display unit that has transparency at a part of the lens part, and it is possible to display various types of information on the display unit. Accordingly, the head-mounted display 12 implements augmented reality in which the real environment is augmented by, while allowing the user wearing the head-mounted display 12 to view the real environment, allowing the user to view various types of information at a part of the field of view. FIG. 3 schematically illustrates a display unit 30 that is provided at a part of a field of view 12A of the user wearing the head-mounted display 12.

The head-mounted display 12 incorporates a camera between two lens parts and the camera enables capturing of an image in the direction of the line of sight of the user wearing the head-mounted display 12.

FIG. 1 will be referred back. The input supporting device 13 is a device that supports the user to make input by gesture. The input supporting device 13 is, for example, a portable information processing device, such as a smartphone or a tablet terminal. The input supporting device 13 may be implemented as a single or multiple computers provided at, for example, a data center. In other words, the input supporting device 13 may be a cloud computer as long as it is communicable with the wearable device 11 and the head-mounted display 12.

The input supporting device 13 recognizes an input by a user's gesture on the basis of information on a variation in the posture of the finger that is transmitted from the wearable device 11 and causes the head-mounted display 12 to display information corresponding to the contents of the recognized input.

Configuration of Each Device

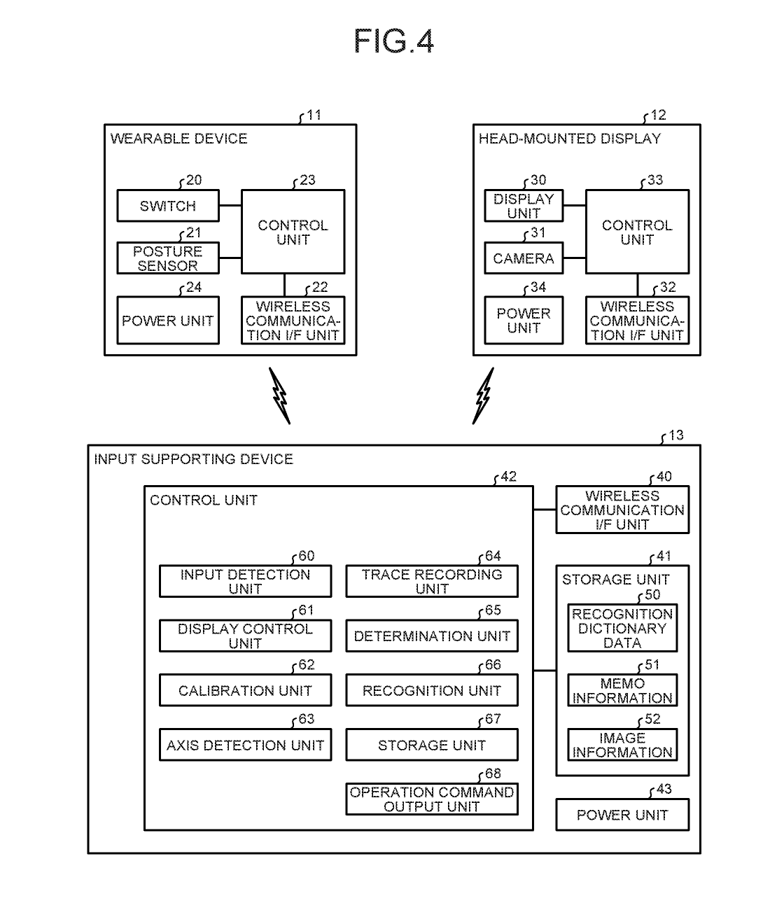

A device configuration of each of the wearable device 11, the head-mounted display 12, and the input supporting device 13 will be explained. FIG. 4 is a diagram illustrating an exemplary device configuration.

First, the wearable device 11 will be explained. As illustrated in FIG. 4, the wearable device 11 includes the switch 20, a posture sensor 21, a wireless communication interface (I/F) unit 22, a control unit 23, and a power unit 24. The wearable device 11 may include another device other than the above-described devices.

The switch 20 is a device that accepts an input from the user. The switch 20 is provided on a side surface of the ring of the wearable device 11 as illustrated in FIG. 2C. The switch 20 is turned on when pressed and turned off when released. The switch 20 accepts operational input from the user. For example, when the wearable device 11 is worn on the index finger of the user, the switch 20 accepts an operational input by the thumb of the user. The switch 20 outputs operational information representing the accepted operational contents to the control unit 23. The user operates the switch 20 to make various types of input. For example, the user turns on the switch 20 when starting input by gesture.

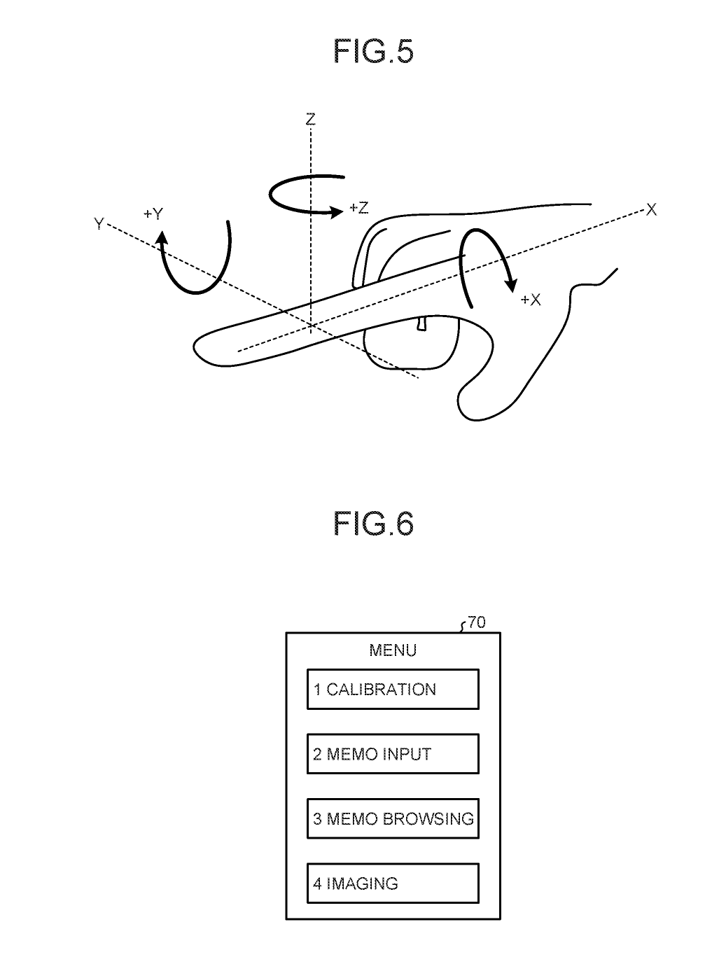

The posture sensor 21 is a device that detects a gesture of the user. For example, the posture sensor 21 is a three-axis gyro sensor. As depicted in FIG. 2C, when the wearable device 11 is correctly worn on the finger, the three axes of the posture sensor 21 are incorporated in the wearable device 11 to correspond to the rotation axes of the finger. FIG. 5 is a diagram illustrating exemplary rotation axes of the finger. In the example illustrated in FIG. 5, three axes X, Y, and Z are illustrated. In the example illustrated in FIG. 5, the Y-axis denotes the axis of rotation in the direction of an operation of bending the finger, the Z-axis denotes the axis of rotation in the direction of an operation of directing the finger leftward/rightward, and the X-axis denotes the axis of rotation in the direction of an operation of turning the finger. In accordance with the control by the control unit 23, the posture sensor 21 detects rotation about each of the rotation axes X, Y, and Z and outputs, to the control unit 23, the detected rotation about the three axes as posture variation information representing a variation in the posture of the finger.

The wireless communication I/F unit 22 is an interface that performs wireless communication control between the wearable device 11 and other devices. For the wireless communication I/F unit 22, it is possible to use a network interface card, such as a wireless chip.

The wireless communication I/F unit 22 is a device that perform communications wirelessly. The wireless communication I/F unit 22 transmits/receives various types of information to/from other devices wirelessly. For example, under the control of the control unit 23, the wireless communication unit I/F 22 transmits operational information and posture variation information to the input supporting device 13.

The control unit 23 is a device that controls the wearable device 11. For the control unit 23, it is possible to use an integrated circuit, such as a microcomputer, an application specific integrated circuit (ASIC), or a field programmable gate array. The control unit 23 controls the wireless communication I/F unit 22 to transmit operational information from the switch 20 to the input supporting device 13. When the switch 20 is turned on, the control unit 23 controls the posture sensor 21 to cause the posture sensor 21 to detect a variation in the posture. The control unit 23 controls the wireless communication I/F unit 22 to transmit posture variation information that is detected by the posture sensor 21 to the input supporting device 13.

The power unit 24 includes a power supply, such as a battery, and supplies power to each electronic part of the wearable device 11.

The head-mounted display 12 will be explained here. As illustrated in FIG. 4, the head-mounted display 12 includes the display unit 30, a camera 31, a wireless communication I/F unit 32, a control unit 33, and a power unit 34. The head-mounted display 12 may include another device other than the above-described devices.

The display unit 30 is a device that displays various types of information. As illustrated in FIG. 3, The display unit 30 is provided at a lens part of the head-mounted display 12. The display unit 30 displays various types of information. For example, the display unit 30 displays a menu screen, a virtual laser pointer, and the trace of an input, which will be described below.

The camera 31 is a device that captures an image. As illustrated in FIG. 3, the camera 31 is provided between the two lens parts. The camera 31 captures an image in accordance with the control by the control unit 33.

The wireless communication I/F unit 32 is a device that performs communications wirelessly. The wireless communication I/F unit 32 transmits/receives various types of information from/to other devices wirelessly. For example, the wireless communication I/F unit 32 receives image information of an image to be displayed on the display unit 30 and an operation command of an instruction for imaging from the input supporting device 13. The wireless communication I/F unit 32 transmits image information of an image that is captured by the camera 31 to the input supporting device 13.

The control unit 33 is a device that controls the head-mounted display 12. For the control unit 33, an electronic circuit, such as a central processing unit (CPU) or a micro processing unit (MPU), or an integrated circuit, such as a microcomputer, an ASIC, or an FPGA, may be used. The control unit 33 performs control to cause the display unit 30 to display image information received from the input supporting device 13. Upon receiving an operation command of an instruction for imaging from the input supporting device 13, the control unit 33 controls the camera 31 to capture an image. The control unit then controls the wireless communication I/F unit 32 to transmit the image information of the captured image to the input supporting device 13.

The power unit 34 includes a power supply, such as a battery, and supplies power to each electronic part of the head-mounted display 12.

The input supporting device 13 will be explained here. As illustrated in FIG. 4, the input supporting device 13 includes a wireless communication I/F unit 40, a storage unit 41, a control unit 42, and a power unit 43. The input supporting device 13 may include another device other than the above-described devices.

The wireless communication I/F unit 40 is a device that performs communications wirelessly. The wireless communication I/F unit 40 transmits/receives various types of information from/to other deices wirelessly. For example, the wireless communication I/F unit 40 receives operation information and posture variation information from the wearable device 11. The wireless communication I/F unit 40 transmits image information of an image to be displayed on the head-mounted display 12 and various operation commands to the head-mounted display 12. The wireless communication I/F unit 40 further receives image information of an image that is captured by the camera 31 of the head-mounted display 12.

The storage unit 41 is a storage device, such as a hard disk, a solid state drive (SSD), or an optical disk. The storage unit 41 may be a data rewritable semiconductor memory, such as a random access memory (RAM), a flash memory, or a non-volatile static random access memory (NVSRAM).

The storage unit 41 stores an operating system (OS) and various programs that are executed by the control unit 42. For example, the storage unit 41 stores various programs that are used for supporting input. Furthermore, the storage unit 41 stores various types of data used for the programs to be executed by the control unit 42. For example, the storage unit 41 stores recognition dictionary data, memo information 51, and image information 52.

Recognition dictionary data 50 is dictionary data for recognizing characters that are input by handwriting. For example, the recognition dictionary data 50 stores standard trace information of various characters.

The memo information 51 is data in which information on a memo that is input by handwriting is stored. For example, in the memo information 51, an image of a character that is input by handwriting and character information that is the result of recognition of the character input by handwriting are stored in association with each other.

The image information 52 is image information of the image captured by the camera 31 of the head-mounted display 12.

The control unit 42 is a device that controls the input supporting device 13. For the control unit 42, an electronic circuit, such as a CPU or a MPU, or an integrated circuit, such as a microcomputer, an ASIC, or an FPGA, may be used. The control unit 42 includes an internal memory for storing programs that define various processing procedures and control data and executes various processes by using the programs and control data. The control unit 42 functions as various processing units because the various programs run. For example, the control unit 42 includes an input detection unit 60, a display control unit 61, a calibration unit 62, an axis detection unit 63, a trace recording unit 64, a determination unit 65, a recognition unit 66, a storage unit 67, and an operation command output unit 68.

The input detection unit 60 detects various inputs on the basis of operation information and posture variation information that are received from the wearable device 11. For example, the input detection unit 60 detects an operation on the switch 20 on the basis of the operation information. For example, the input detection unit 60 detects, from the number of times the switch 20 is pressed within a given time, a single click, a double click, a triple click, or a long press operation on the switch 20. The input detection unit 60 detects a variation in the posture of the finger depending on rotation of the three axes from the posture variation information that is received from the wearable device 11.

The display control unit 61 performs various types of display control. For example, the display control unit 61 generates image information on various screens in accordance with the result of detection by the input detection unit 60 and controls the wireless communication I/F unit 40 to transmit the generated image information to the head-mounted display 12. Accordingly, the image of the image information is displayed on the display unit 30 of the head-mounted display 12. For example, when the input detection unit 60 detects a double click, the display control unit 61 causes the display unit 30 of the head-mounted display 12 to display a menu screen.

FIG. 6 is a diagram depicting an exemplary menu screen. As depicted in FIG. 6, a menu screen 70 displays items of “1 CALIBRATION”, “2 MEMO INPUT”, “3 MEMO BROWSING”, and “4 IMAGING”. The item of “1 CALIBRATION” is for specifying a calibration mode in which calibration is performed on the detected posture information on the finger. The item of “2 MEMO INPUT” is for specifying a memo input mode in which a memo is input by handwriting. The item of “3 MEMO BROWSING” is for specifying a browsing mode in which the memo that has been input is browsed. The item of “4 IMAGING” is for specifying an imaging mode in which an image is captured by using the camera 31 of the head-mounted display 12.

With the input supporting device 13 according to the first embodiment, it is possible to select items on the menu screen 70 by handwriting input or by using a cursor. For example, when the recognition unit 66, which will be described below, recognizes the trace input by handwriting as a number from “1” to “4”, the display control unit 61 determines that the mode of the item corresponding to the recognized number is selected. The display control unit 61 displays a cursor on the screen and moves the cursor in accordance with the variation in the posture of the finger that is detected by the input detection unit 60. For example, when rotation of the Y-axis is detected, the display control unit 61 moves the cursor leftward/rightward on the screen at a speed according to the rotation. When rotation of the Z-axis is detected, the display control unit 61 moves the cursor upward/downward on the screen at a speed according to the rotation. When the cursor is positioned on any one of the items on the menu screen 70 and the input detection unit 60 detects a single click, the display control unit 61 determines that the mode of the item at which the cursor is positioned is selected. When any one of the items on the menu screen 70 is selected, the display control unit 61 deletes the menu screen 70.

The calibration unit 62 performs calibration on the information on the detected posture of the finger. For example, when the calibration mode is selected on the menu screen 70, the calibration unit 62 performs calibration on the information on the detected posture of the finger.

The wearable device 11 may be worn in a shifted state where the wearable device 11 turns in the circumferential direction with respect to the finger. When the wearable device 11 is worn on the finger in the shifted state, a shift corresponding to the turn may occur in the posture variation detected by the wearable device 11 and thus the detected motion may be different from that intended by the user. In such a case, the user selects the calibration mode on the menu screen 70. Once the user selects the calibration mode on the menu screen 70, the user opens and closes the hand wearing the wearable device 11 on the finger. The wearable device 11 transmits, to the input supporting device 13, posture variation information on the variation in the posture of the finger occurring when the hand is opened and closed.

On the basis of the posture variation information, the calibration unit 62 detects a motion of the finger that is caused when the finger on which the wearable device 11 is worn is bend and stretched and that is a motion caused by opening and closing the hand. The calibration unit 62 performs calibration on the reference direction of finger motion on the basis of the detected motion of the finger.

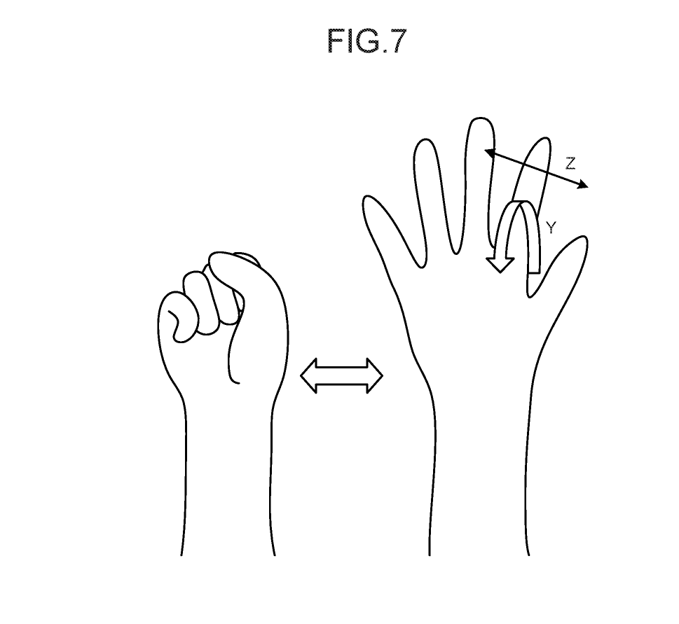

FIG. 7 is a diagram explaining the reference direction of finger motions. FIG. 7 represents a diagram illustrating that the hand is opened and closed. When the hand is opened and closed, the motion of the finger is limited to bending and stretching. The variation in the posture of the finger due to the stretching and bending motion appears mainly in the rotation of the Y-axis.

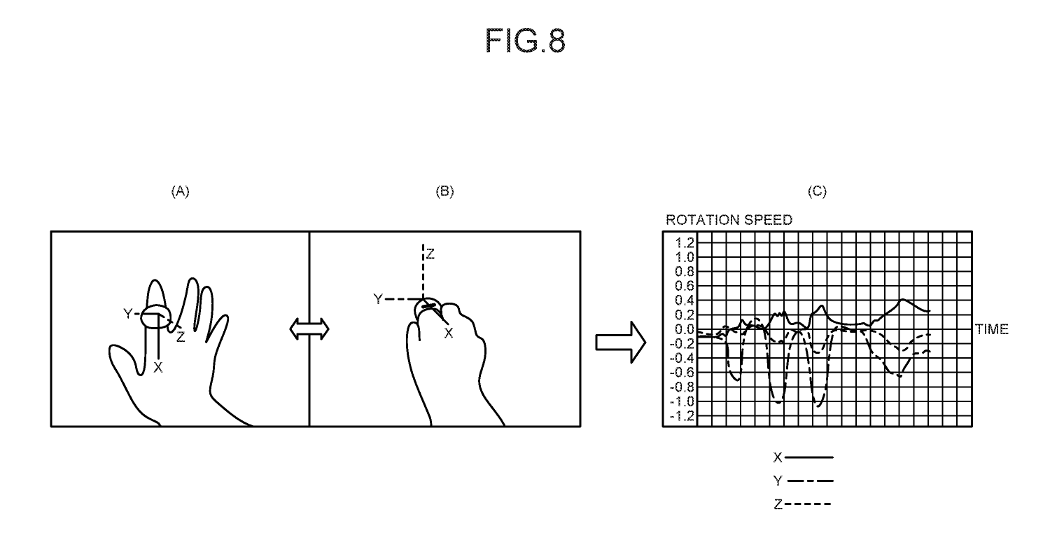

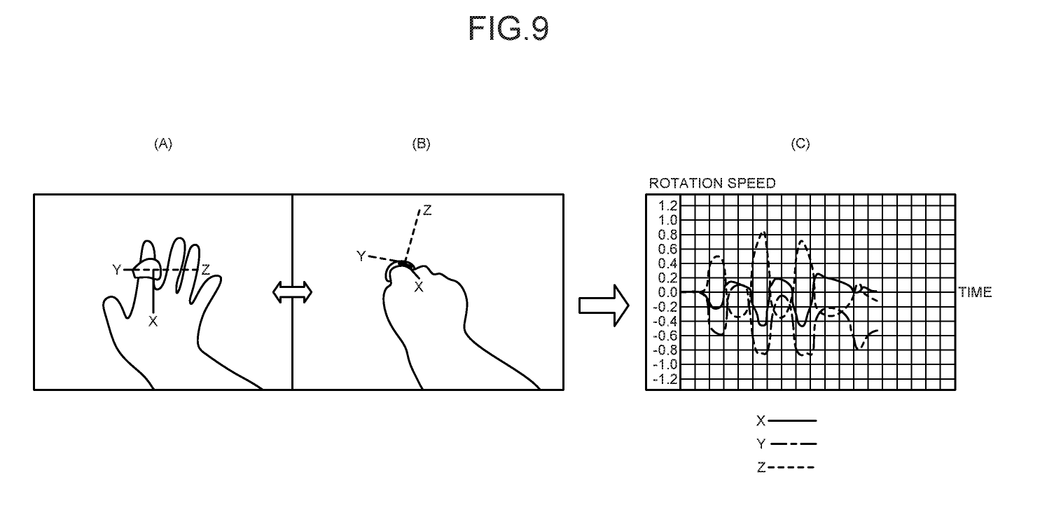

FIGS. 8 and 9 illustrates variations in the rotation speed of each of the rotation axes X, Y, and Z over time that are detected when the hand wearing the wearable device 11 is opened and closed. FIG. 8 is a diagram illustrating variations in the rotation speed in a state where the wearable device is normally worn. FIG. 9 is a diagram illustrating a variation in the rotation speed in a state where the wearable device is obliquely shifted and worn. FIGS. 8(A) and 8(B) and FIGS. 9(A) and 9(B) represent each of rotation axes of X, Y, and Z of the wearable device 11 in a state where the hand is opened and a state where the hand is closed. In the state where the wearable device 11 is worn normally, rotation is detected mainly in the Y-axis as illustrated in FIG. 8(C). On the other hand, when the wearable device 11 is shifted and worn, rotation is detected mainly in the Y-axis and the X-axis as illustrated in FIG. 9(C).

On the basis of the posture variation information obtained when the finger is bent and stretched, the calibration unit 62 calculates correction information with which the reference direction of the motion of the finger is corrected. For example, the calibration unit 62 calculates, as correction information, angles of rotation to which the rotation axes X, Y, and Z illustrated in FIG. 8(C) are corrected respectively to the rotation axes X, Y, and Z illustrated in FIG. 9.

When the calibration by the calibration unit 62 ends, the input detection unit 60 corrects the posture variation information by using the correction information that is calculated by the calibration unit 62 and detects a variation in the posture. By correcting the posture variation information by using the correction information, the posture variation information is corrected to one based on each of the rotation axes of X, Y, and Z illustrated in FIG. 8.

The axis detection unit 63 detects an axis representing the posture on the basis of the variation in the posture of the finger that is detected by the input detection unit 60. For example, the axis detection unit 63 detects an axis whose direction moves in accordance with the variation in the posture of the finger. For example, the axis detection unit 63 calculates direction vectors of the axes that pass through the origin in a three-dimensional space and that move in the respective directions of X, Y, and Z in accordance with the respective directions of rotation and the respective rotation speeds with respect to the respective rotation axes of X, Y, and Z. When the motion is detected according to only the posture, it is difficult to move the wrist widely as it separates from the correct direction. When the hand palm is kept horizontal, its rightward and leftward flexibility may be low while its upward and downward flexibility is high. The axis detection unit 63 may change the pointing sensitivity in the upward/downward direction and the leftward/rightward direction from the center point in the axis direction that is corrected by the calibration unit 62. For example, the axis detection unit 63 calculates a vector of the direction of an axis by largely correcting the rotation of the hand in the rightward/leftward direction compared to correction on the rotation of the hand in the upward/downward direction. In other words, when the amounts of rotation are the same, the axis detection unit 63 corrects the amount of move due to the rightward/leftward rotation largely compared to correction on the amount of move due to the upward/downward rotation. Furthermore, the axis detection unit 63 may increase the sensitivity as it is apart from the center point of the direction of the corrected axis. For example, the axis detection unit 63 largely corrects the rotation as it is apart from the center point in the direction of the axis and calculates the direction vector of the axis. In other words, when the amounts of rotation are the same, the axis detection unit 63 corrects the amount of move due to the rotation in a peripheral area apart from the center point in the axis direction largely compared to correction on the amount of move due to rotation near the center point. Accordingly, the sensitivity of rotation is set in accordance with easiness of moving the wrist and this enables the input system 10 to easily perform accurate pointing.

The display control unit 61 causes the display unit 30 of the head-mounted display 12 to display a virtual laser pointer that moves in association with the axis detected by the axis detection unit 63. For example, when the calibration mode is selected on the menu screen 70, the display control unit 61 generates image information of a screen where a virtual laser pointer that moves in association with the axis detected by the axis detection unit 63 is arranged. The display control unit 61 controls the wireless communication I/F unit 40 to transmit the generated image information to the head-mounted display 12. Accordingly, the image of the virtual laser pointer is displayed on the display unit 30 of the head-mounted display 12.

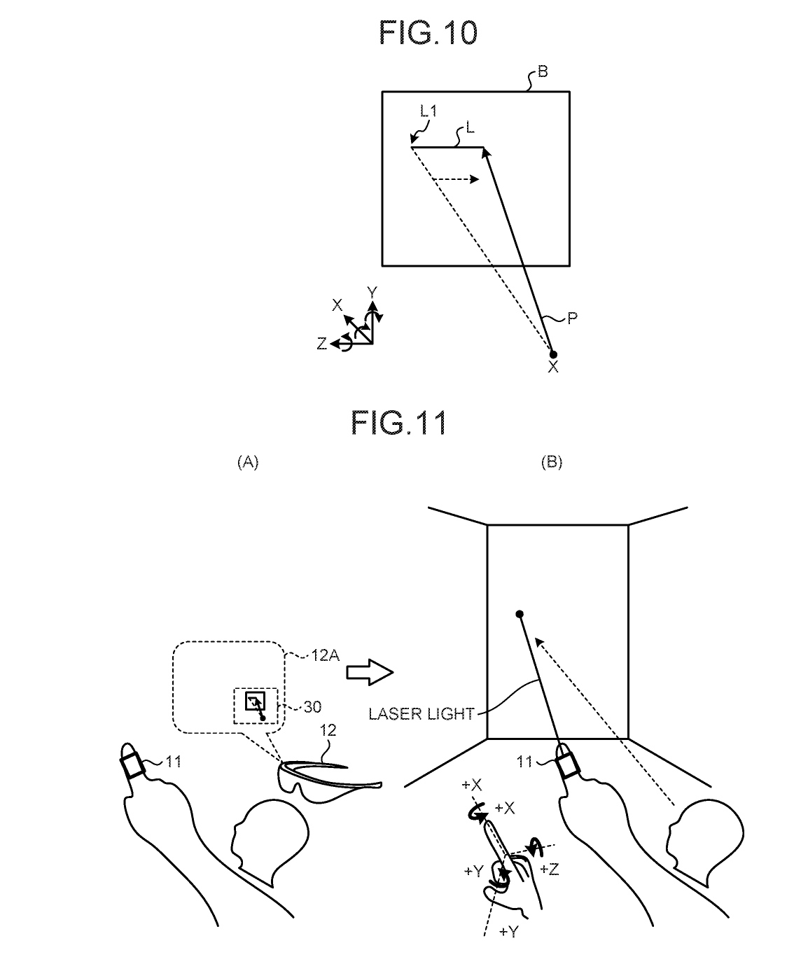

FIG. 10 is a diagram illustrating an exemplary virtual laser pointer to be displayed. FIG. 10 illustrates a virtual laser pointer P toward a virtual surface B that is provided at the front with respect to an origin X. The laser pointer P moves in association with a variation in the posture that is detected by the wearable device 11.

The trace recording unit 64 detects a gesture relating to input. For example, the trace recording unit 64 detects a character that is handwritten by gesture in a free space. For example, when the input detection unit 60 detects an operation of a long-press operation on the switch 20, the trace recording unit 64 detects the handwritten character by recording the trace of the axis during the long-press operation.

The display control unit 61 also displays the trace of the axis recorded by the trace recording unit 64. According to the example illustrated in FIG. 10, a trace L is displayed on the virtual screen B. A start point L1 of the trace L is the position at which the switch 20 is pressed. The trace L is not necessarily displayed together with the laser pointer P. For example, the display control unit 61 may divide the screen into two areas and display the trace L and the laser pointer P in the different areas.

Displaying the laser pointer P as described above enables the user wearing the head-mounted display 12 to easily make input to the free space. When the user makes input to the free space by using a finger, the detected motion of the finger contains translational components and rotational components. The translational components come from parallel movement of the hand and movement of the whole body of the user, and thus it is difficult to detect only motions of the finger. For this reason, the detected motion may differ from that intended by the user and it may be difficult to make input by using the finger. The input supporting device 13 detects rotation components that are a variation in the posture of the finger, detects an axis representing the posture of the finger from the detected rotation components, displays a virtual laser pointer that moves in association with the axis, and sends the result of detection as a feedback to the user.

FIG. 11 is a diagram illustrating an exemplary feedback to the user. According to FIG. 11(A), a virtual laser pointer is displayed on the display unit 30 of the head-mounted display 12. Viewing the virtual laser pointer via the head-mounted display 12 allows the user to easily know which input is made due to a variation in the posture of the finger, which makes it easy to make input. Furthermore, viewing the virtual laser pointer via the head-mounted display 12 allows the user to, while viewing the real environment, implement augmented reality in which the real environment is augmented. For example, as depicted in FIG. 11(B), a virtual wall appears in the real environment in the free space, which enables viewing that handwriting is performed on the virtual wall by using the laser pointer. As described above, because the input supporting device 13 sends the result of the detection as a feedback to the user and accordingly the user easily know a fine variation in the input, for example, it is possible to improve the recognition rate in a case where complicated characters, such as Kanji, are input. Because the input supporting device 13 detects rotation components that are a variation in the posture of the finger and makes an input, for example, it is possible for the user to make input even while the user is moving.

The determination unit 65 determines a gesture that is a subject not to be input. For example, a gesture that satisfies a given condition from among detected gestures is determined as a subject not to be input.

The trace of a character that is handwritten by gesture in the free space contains a line part referred to as a stroke and a moving part that move between line parts. When a handwritten character contains a moving part, it is difficult to recognize the character, and it may be recognized as a character different from that intended by the user. A handwritten character having many strokes tends to be erroneously recognized. Particularly, because a one-stroke character contains many moving parts, it is difficult to recognize the character.

On the other hand, many characters, such as kanji, are written with movement from the left to the right or from the top to the bottom. In many cases, movement to the upper left is movement between line parts.

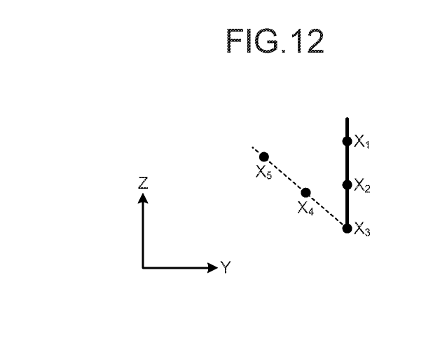

It is assumed that the given condition is a gesture of movement to the upper left. The determination unit 65 determines a gesture of movement to the upper left as a subject not to be input and determines gestures other than the gesture of movement to the upper left as subjects to be input. FIG. 12 is a diagram illustrating exemplary determination of a gesture. FIG. 12 illustrates a result of sampling the position of the axis during a long-press operation in a given period. The determination unit 65 compares each sampled position with the position previously sampled and, when the sampled position is on the upper left with respect to the previously-sampled position, the determination unit 65 determines that the gesture is a subject not to be input. For example, as for points X₄ and X₅, because the Y coordinate is negative and the Z coordinate is negative and it moves to the upper left, it is determined as a subject not to be input.

The display control unit 61 displays subjects not to be input and subjects to be input separately. For example, the display control unit 61 displays a subject not to be input with visibility lower than that of a subject to be input. For example, the display control unit 61 displays the trace of a gesture that is determined as a subject not to be input in a color lighter than that of the trace of a gesture determined as a subject to be input. According to the example illustrated in FIG. 12, the gradation values of the traces of the points X₄ and X₅ are set lower than those of the traces of points X₁ to X₃ and thus the traces are displayed in a color lighter than that of the points X₁ to X₃. In order to easily discriminating the line parts displayed in a light color, the line parts displayed in the light color are represented by dashed line. In the example illustrated in FIG. 12, the line part displayed in the light color is represented by a dashed line.

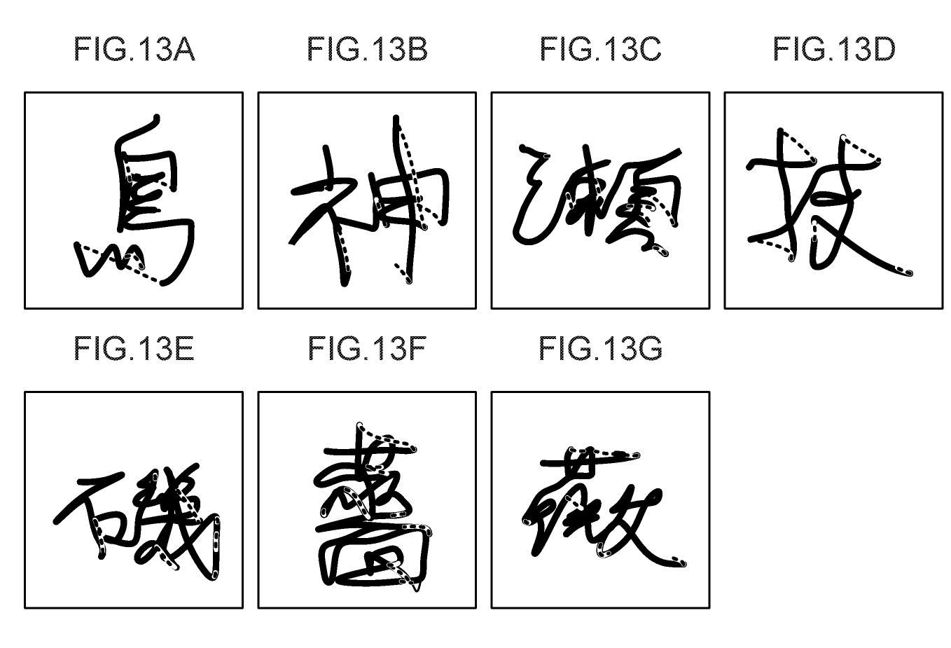

FIGS. 13A to 13G are a diagram illustrating exemplary results of display of traces of characters that are input by handwriting. FIG. 13A is an example where “ [symbol] ” is input by handwriting. FIG. 13B is an example where “ [symbol] ” is input by handwriting. FIG. 13C is an example where “ [symbol] ” is input by handwriting. FIG. 13D is an example where “ [symbol] ” is input by handwriting. FIG. 13E is an example where “ [symbol] ” is input by handwriting. FIG. 13F is an example where “ [symbol] ” is input by handwriting. FIG. 13G is an example where “ [symbol] ” is input by handwriting. As illustrated in FIGS. 13(A) to 13(F), separately displaying traces that move to the upper left in a light color enables easy recognition of characters represented by traces. In the example illustrated in FIGS. 13A to 13G, the line parts displayed in a light color are displayed in dashed lines.

The display control unit 61 may display subjects not to be input with visibility lower than that of subjects to be input by changing the color. For example, the display control unit 61 may display subjects not to be input in red and display subjects to be input in gray. Alternatively, the display control unit 61 may delete the trace of a gesture determined as a subject not to be input and display the trace of a gesture determined as a subject to be input. In other words, the display control unit 61 may perform display control such that the traces of the points X₄ and X₅ according to the example illustrated in FIG. 12 are not displayed.

The recognition unit 66 recognizes a character from the trace that is recorded by the trace recording unit 64. For example, the recognition unit 66 performs character recognition on traces determined as subjects to be input from among traces that are recorded by the trace recording unit 64. For example, the recognition unit 66 performs character recognition on the traces that are represented by dark lines according to FIGS. 13A to 13G. The recognition unit 66 compares a trace determined as a subject to be input with standard traces of various characters stored in the recognition dictionary data 50 and specifies a character with the highest similarity. The recognition unit 66 outputs a character code of the specified character. When inputting a character by handwriting, the user makes input by performing a long-press operation on the switch 20 per character. In other words, the switch 20 is released once per character. The trace recording unit 64 records the trace of the input by handwriting per character. The recognition unit 66 recognizes characters from the traces one by one.

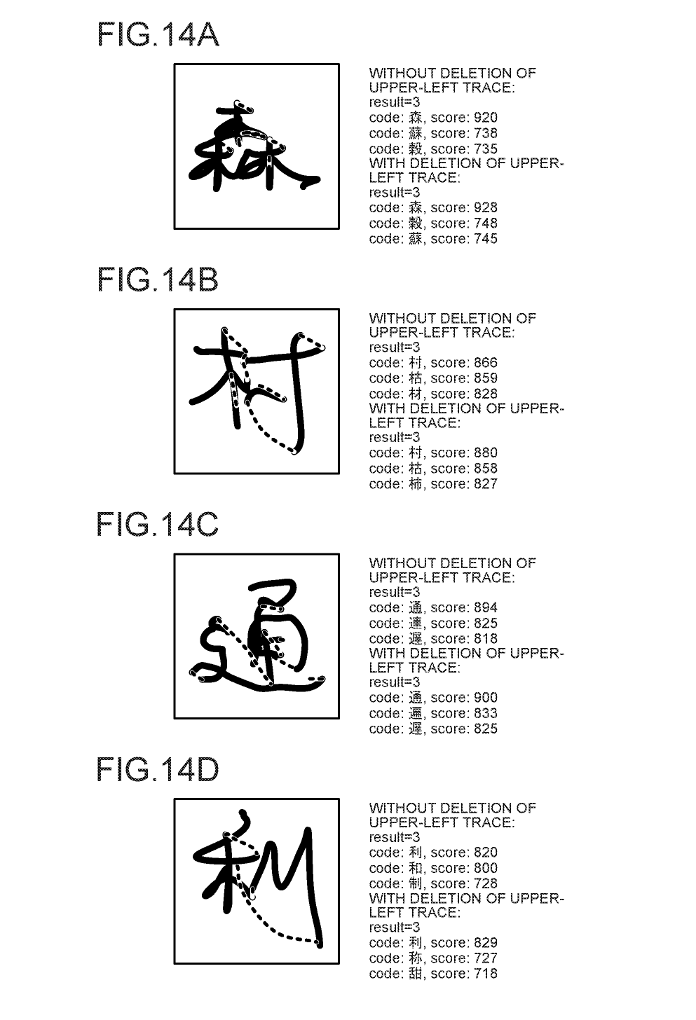

FIGS. 14A to 14D are a diagram illustrating exemplary results of character recognition. In the example illustrated in FIGS. 14A to 14D, line parts displayed in a light color are represented by dashed lines. FIG. 14A illustrates the result of character recognition on “ [symbol] ” that is input by handwriting. FIG. 14B illustrates the result of character recognition on “ [symbol] ” that is input by handwriting. FIG. 14C illustrates the result of character recognition on “ [symbol] ” that is input by handwriting. FIG. 14D illustrates the result of character recognition on “ [symbol] ” that is input by handwriting. FIGS. 14A to 14D illustrates candidate characters and scores representing similarity in a case where character recognition is performed without deleting the upper-left traces of move to the upper left and a case where character recognition is performed after the upper-left traces of move to the upper left is deleted. The candidate characters are represented after “code:”. The score represents similarity. The larger the value of the score is, the higher the similarity is. For example, as for “ [symbol] ” that is input by handwriting, the score is 920 when character recognition is performed without deleting the upper-left traces and the score is 928 when character recognition is performed after the upper-left traces are deleted, i.e., the score is higher when the upper-left traces are deleted. Furthermore, deleting the upper-left traces reduces erroneous conversion. For example, for “ [symbol] ” that is input by handwriting, there are “ [symbol] ”, “ [symbol] ”, and “ [symbol] ” as recognition candidates. The score is higher when the upper-left trace are deleted, which reduces erroneous conversion.

When a character recognized by the recognition unit 66 has a hook, the display control unit 61 displays the trace corresponding to the hook of the character from among traces of gestures determined as subjects not to be input as the trace of a gesture determined as a subject to be input is displayed. For example, the trace recording unit 64 changes the trace corresponding to the hook of the character from among the recorded traces as the trace of a character part is changed. The display control unit 61 displays an image of the character that is changed by the trace recording unit 64.

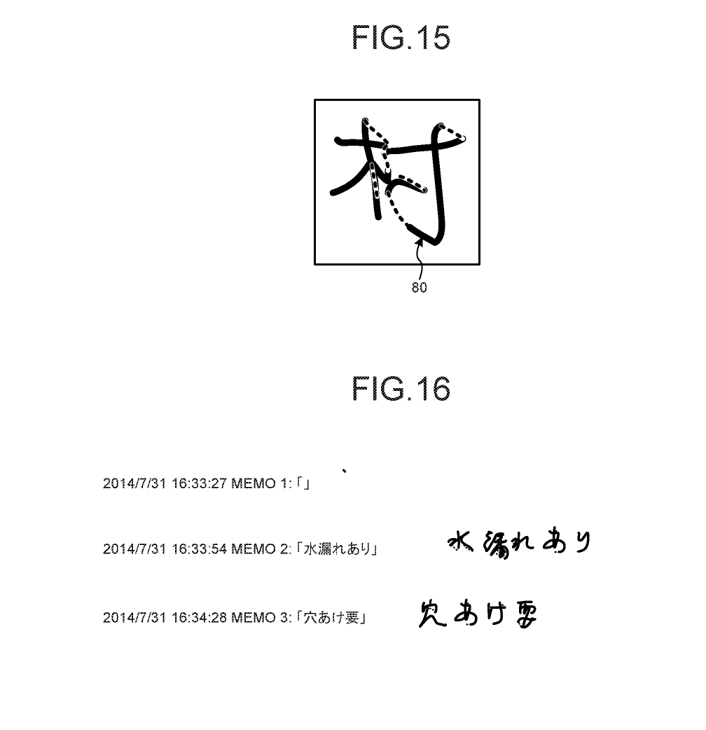

FIG. 15 is a diagram illustrating an exemplary result of display of a trace corresponding to a hook of a character. In the example illustrated in FIG. 15, line parts displayed in a light color are represented by dashed lines. FIG. 15 illustrates the result of display of “ [symbol] ” that is input by handwriting. A trace 80 corresponding to a hook of the character “ [symbol] ” that is input by handwriting is displayed as other parts of the character are displayed. Displaying the trace corresponding to a hook of a character in this manner enables easy recognition of handwritten characters.

The storage unit 67 performs various types of storage. For example, the storage unit 67 stores the trace of a handwritten character and a recognized character in the memo information 51. For example, when the memo input mode is selected on the menu screen 70, the storage unit 67 stores, in the memo information 51, an image of the character recorded by the trace recording unit 64 and the character recognized by the recognition unit 66 in association with each other together with date information. It is possible to refer to the information stored in the memo information 51. For example, when the memo input mode is selected on the menu screen 70, the display control unit 61 displays the information that is stored in the memo information 51 of the storage unit 41.

FIG. 16 is a diagram illustrating an exemplary display of saved contents of memo information. In the example illustrated in FIG. 16, the line parts displayed in a light color are represented by dashed lines. In the example illustrated in FIG. 16, a date at which a memo input is made, a phrase of a text obtained by recognizing handwritten characters and a phrase of an image of the handwritten characters are displayed in association with one another. Displaying the phrase of the text and the phrase of the image of the handwritten characters in association with each other enables the user to check whether the handwritten characters are correctly recognized. Furthermore, displaying a phrase of a text and a phrase of an image of handwritten characters in association with each other enables the user to know, even when the characters are erroneously converted in trace recognition, the handwritten characters by referring to the image of the corresponding characters. Furthermore, characteristics of the user's handwriting are recorded in the image of the handwritten characters. Because the image of the handwritten characters is stored, it is possible to use the image as, for example, signature as authentication of the input by the user.

The operation command output unit 68 outputs an operation command to another device in accordance with the recognized character or a symbol. For example, when performing imaging by using the camera 31 of the head-mounted display 12, the user selects the imaging mode on the menu screen 70. At a timing at which imaging is desired, the user performs the long-press operation on the switch 20 of the wearable device 11 and inputs a given sentence by handwriting. The given character may be any of character, number, and symbol. For example, it may be “1”. When the imaging mode is selected on the menu screen 70, the operation command output unit 68 enters an imaging preparation state. The trace recording unit 64 records the trace that is input by handwriting in the imaging preparation state. The recognition unit 66 recognizes a character from the trace. When the recognition unit 66 recognizes the given character, the operation command output unit 68 transmits an operation command for instruction for imaging to the head-mounted display 12. Upon receiving the operation command for the instruction for imaging, the head-mounted display 12 performs imaging by using the camera 31 and transmits image information of the captured image to the input supporting device 13. The storage unit 67 stores the image information of the captured image as the image information 52 in the storage unit 41. In this manner, the input supporting device 13 is capable of outputting an operation command to another device to perform an operation.

The power unit 43 includes a power source, such as a battery, and supplies power to each electronic part of the input supporting device 13.

Process Flow

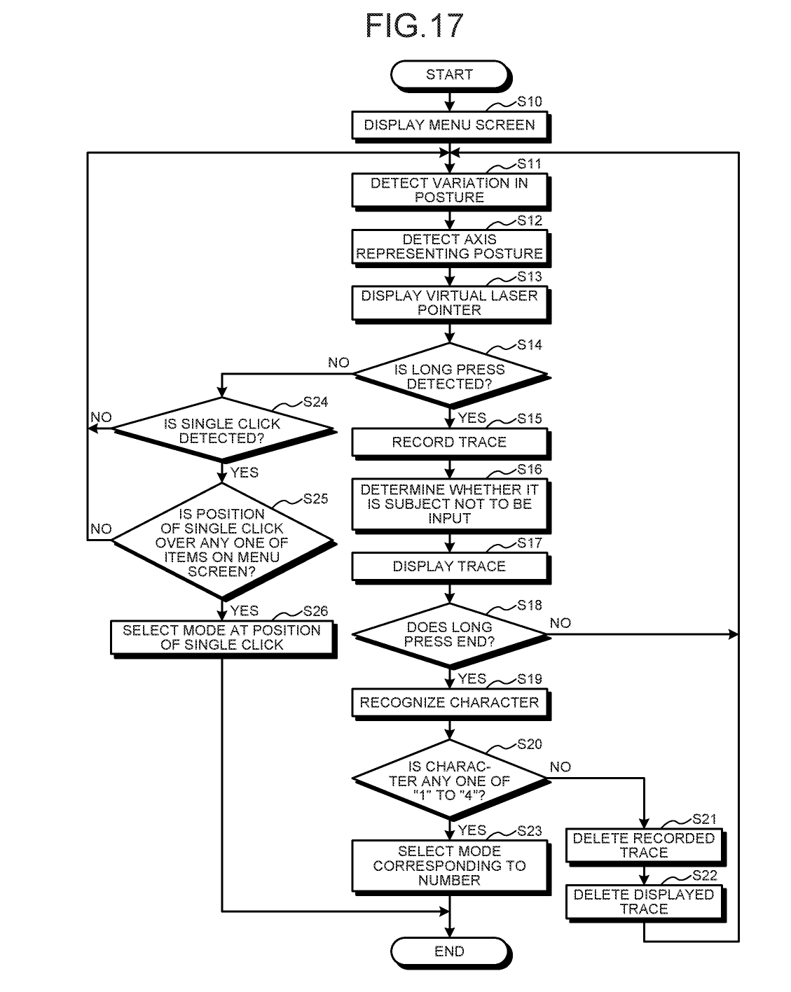

A flow of making input by the input supporting device 13 will be described. First, a flow of a menu process of accepting mode selection on the menu screen will be explained. FIG. 17 is a flowchart illustrating an exemplary procedure of the menu process. The menu process is executed at a given timing at which, for example, the input detection unit 60 detects a double click.

As illustrated in FIG. 17, the display control unit 61 generates image information of a screen on which the menu screen 70 is arranged at a part of a display area and transmits the generated image information to the head-mounted display 12 to cause the display unit 30 to display the menu screen 70 (S10). The input detection unit 60 detects a variation in the posture of a finger depending on rotation of the three axes from posture variation information that is received from the wearable device 11 (S11). The axis detection unit 63 detects an axis representing the posture on the basis of the variation in the posture of the finger that is detected by the input detection unit 60 (S12). The display control unit 61 generates image information of a screen on which a virtual laser pointer is arranged in a display area different from the display area of the menu screen 70 and transmits the generated image information to the head-mounted display 12 to cause the display unit 30 to display a virtual laser pointer (S13).

The display control unit 61 determines whether the input detection unit 60 detects a long-press operation on the switch 20 (S14). When the long-press operation on the switch 20 is detected (YES at S14), the trace recording unit 64 records the trace of the axis (S15). The determination unit 65 determines whether a gesture is a subject not to be input (S16). For example, the determination unit 65 determines a gesture of move to the upper left as a gesture not to be input and determines gestures other than the gesture of move to the upper left as gestures to be input. The display control unit 61 generates image information of a screen where the recorded trace of the axis is displayed on a virtual surface that is the display area for the virtual laser pointer and transmits the generated image information to the head-mounted display 12 to cause the display unit 30 to also display the trace of the axis (S17). The display control unit 61 displays subjects to be input and subjects not to be input separately. For example, the display control unit 61 displays the trace of a subject not to be input with visibility lower than that of the trace of a subject to be input. The display control unit 61 determines whether the long-press operation on the switch 20 detected by the input detection unit 60 ends (S18). When the long-press operation on the switch 20 does not end (NO at S18), the process moves to S11.

On the other hand, when the long-press operation on the switch 20 ends (YES at S18), the recognition unit 66 recognizes a character from the trace recorded by the trace recording unit 64 (S19). The display control unit 61 determines whether the recognition unit 66 recognizes any one of the numbers of “1” to “4” (S20). When none of the numbers of “1” to “4” is recognized (NO at S20), the trace recording unit 64 deletes the trace of the axis (S21). The display control unit 61 generates image information of the screen from which the trace of the axis displayed on the virtual surface that is the display area for the virtual laser pointer has been deleted and transmits the generated image information to the head-mounted display 12 to delete the trace of the axis (S22), and the process then moves to the above-described S11.

On the other hand, when any one of the numbers of “1” to “4” is recognized (YES at S20), the display control unit 61 determines that the mode of the item corresponding to the recognized number is selected and deletes the menu screen (S23), and thus then process ends.

On the other hand, when the long-press operation on the switch 20 is not detected (NO at S14), the display control unit 61 determines whether the input detection unit 60 detects a single click on the switch 20 (S24). When no single click on the switch 20 is detected (NO at S24), the process moves to S11 described above.

On the other hand, when a single click on the switch 20 is detected (YES at S24), the display control unit 61 determines whether the position at which the single click is detected is on any one of the items on the menu screen 70 (S25). When the position at which the single click is detected is on none of the items on the menu screen 70 (NO at S25), the process moves to the above-described S11. On the other hand, when the position at which the single click is detected is on any of the items on the menu screen 70 (YES at S25), the display control unit 61 determines that the mode of the item on which the cursor is positioned is selected and deletes the menu screen 70 (S26), and the process ends.

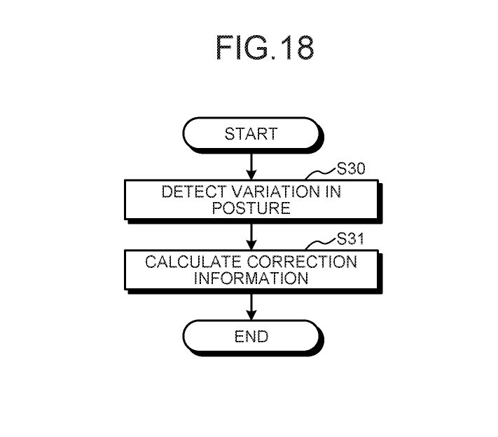

A flow of a calibration process of performing calibration on posture information on a finger will be explained here. FIG. 18 is a flowchart illustrating an exemplary procedure of the calibration process. The calibration process is executed at a given timing at which, for example, the calibration mode is selected on the menu screen 70. Once the user selects the calibration mode on the menu screen 70, the user opens and closes the hand wearing the wearable device on a finger.

As illustrated in FIG. 18, on the basis of posture variation information received from the wearable device 11, the calibration unit 62 detects a motion of the finger that is caused when the finger on which the wearable device 11 is worn is bend and stretched and that is a motion caused by opening and closing the hand (S30). On the basis of the information on the variation in the posture caused when the finger is bent and stretched, the calibration unit 62 calculates correction information with which the reference direction of finger motion is corrected (S31), and the process ends.

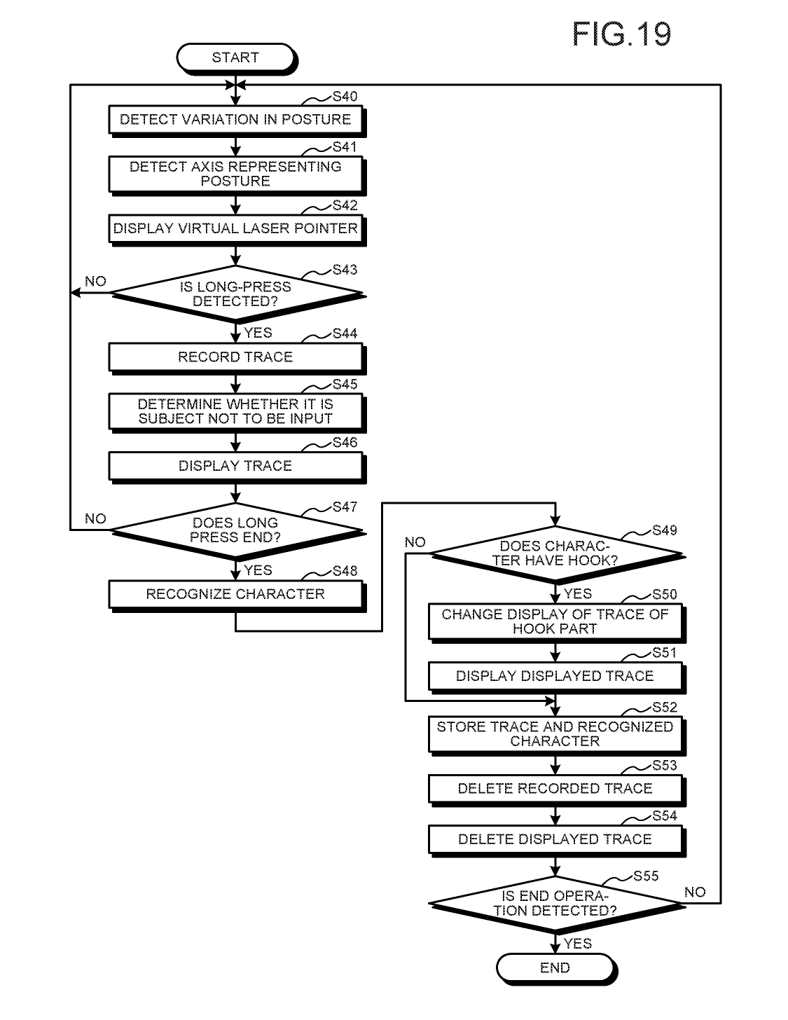

A flow of a memo input process of inputting a memo by handwriting will be explained. FIG. 19 is a flowchart illustrating an exemplary procedure of the memo input process. The memo input process is executed at a given timing at which, for example, the memo input mode is selected on the menu screen 70.

As illustrated in FIG. 19, the input detection unit 60 detects a variation in the posture of a finger depending on rotation of the three axes from posture variation information that is received from the wearable device 11 (S40). The axis detection unit 63 detects an axis representing the posture on the basis of the variation in the posture of the finger that is detected by the input detection unit 60 (S41). The display control unit 61 generates image information of a screen where a virtual laser pointer is arranged in a part of a display area and transmits the generated image information to the head-mounted display 12 to cause the display unit 30 to display the virtual laser pointer (S42).

The display control unit 61 determines whether the input detection unit 60 detects a long-press operation on the switch 20 (S43). When no long-press operation on the switch 20 is detected (NO at S43), the process moves to S40.

On the other hand, when a long-press operation on the switch 20 is detected (YES at S43), the trace recording unit 64 records the trace of the axis (S44). The determination unit 65 determines whether a gesture is a subject not to be input (S45). For example, the determination unit 65 determines a gesture of move to the upper left as a subject not to be input and determines gestures other than the gesture of move to the upper left as gestures to be input. The display control unit 61 generates image information of a screen where the recorded trace of the axis is displayed on a virtual surface that is the display area for the virtual laser pointer and transmits the generated image information to the head-mounted display 12 to cause the display unit 30 to also display the trace of the axis (S46). The display control unit 61 displays subjects to be input and subjects not to be input separately. For example, the display control unit 61 displays the trace of a subject not to be input with visibility lower than that of the trace of a subject to be input. The display control unit 61 determines whether the long-press operation on the switch 20 detected by the input detection unit 60 ends (S47). When the long-press operation on the switch 20 does not (NO at S47), the process moves to S40.

On the other hand, when the long-press operation on the switch 20 ends (YES at S47), the recognition unit 66 recognizes a character from the trace recorded by the trace recording unit 64 (S48). The display control unit 61 determines whether the character recognized by the recognition unit 66 has a hook (S49). When there is no hook (NO at S49), the process moves to S52. When there is a hook (YES at S49), the trace recording unit 64 changes the trace corresponding to the hook of the character from among the recorded trace similarly to the trace of character parts (S50). The display control unit 61 displays the trace changed by the trace recording unit 64 (S51).

The storage unit 67 stores the image of the trace of the character and the character recognized by the recognition unit 66 in the memo information 51 (S52). The trace recording unit 64 deletes the trace of the axis (S53). The display control unit 61 generates image information of the screen from which the trace of the axis displayed on the virtual surface that is the display area for the virtual laser printer has been deleted and transmits the generated image information to the head-mounted display 12 to delete the trace of the axis displayed on the virtual surface of the display unit 30 (S54). The display control unit 61 may temporarily display the character recognized by the recognition unit 66.

The display control unit 61 determines whether the input detection unit 60 detects a given end operation of ending handwriting input (S55). The end operation is, for example, a triple click. When the given end operation is not detected (NO at S55), the process moves to S40 described above. On the other hand, when the end operation is detected (YES at S55), the process ends.

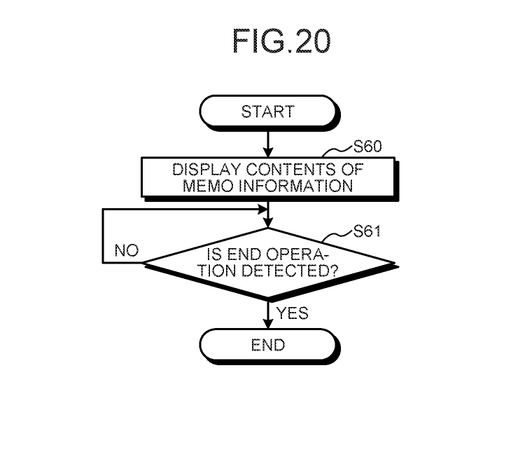

A memo browsing process of browsing a memo will be explained here. FIG. 20 is a flowchart illustrating an exemplary procedure of the memo browning process. The memo browsing process is executed at a given timing at which, for example, the browsing mode is selected on the menu screen 70.

As illustrated in FIG. 20, the display control unit 61 reads the memo information 51 in the storage unit 41, generates image information of a screen where the contents of the memo information 51 is arranged at a part of a display area and transmits the generated image information to the head-mounted display 12 to display the memo information 51 (S60).

The display control unit 61 determines whether the input detection unit 60 detects a given end operation of ending handwriting input (S61). The end operation is, for example, a triple click. When the given end operation is not detected (NO at S61), the process moves to S61 described above. On the other hand, when the end operation is detected (YES at S61), the display control unit 61 ends the display of the information in the memo information 51 and the process ends.

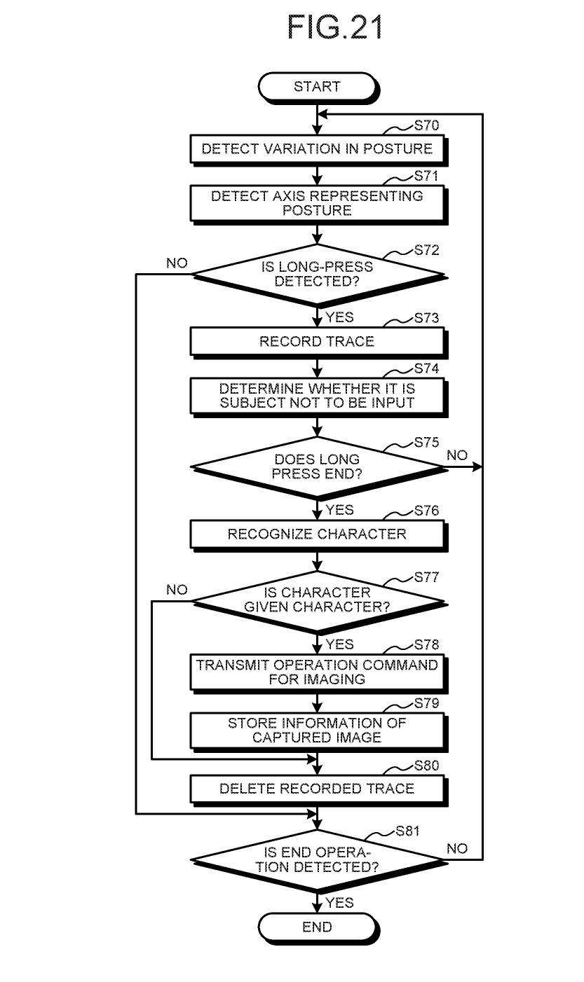

An operation command output process of outputting an operation command for imaging will be explained here. FIG. 21 is a flowchart illustrating an exemplary procedure of the operation command output process. The operation command output process is executed at a given timing at which, for example, the imaging mode is selected on the menu screen 70.

As illustrated in FIG. 21, the input detection unit 60 detects a variation in the posture of the finger depending on rotation of the three axes from posture variation information received from the wearable device 11 (S70). On the basis of the variation in the posture of the finger that is detected by the input detection unit 60, the axis detection unit 63 detects an axis representing the posture (S71). According to the first embodiment, no virtual laser pointer is displayed so as not to hinder imaging in the imaging mode; however, a virtual laser pointer may be displayed.

The display control unit 61 determines whether the input detection unit 60 detects the long-press operation on the switch 20 (S72). When no long-press operation on the switch 20 is detected (NO at S72), the process moves to S81.

On the other hand, when the long-press operation on the switch 20 is detected (YES at S72), the trace recording unit 64 records the trace of the axis (S73). The determination unit 65 determines whether the gesture is a subject not to be input (S74). For example, the determination unit 65 determines a gesture of move to the upper left as a subject not to be input and determines gestures other than the gesture of move to the upper left as subjects to be input. The display control unit 61 determines whether the long-press operation on the switch 20 that is detected by the input detection unit 60 ends (S75). When the long-press operation on the switch 20 does not end (NO at S75), the process moves to S70 described above.

On the other hand, when the long-press operation on the switch 20 ends (YES at S75), the recognition unit 66 recognizes a character from the trace recorded by the trace recording unit 64 (S76). The operation command output unit 68 determines whether the recognition unit 66 recognizes a given character (S77). When the given character is recognized (YES at S77), the operation command output unit 68 transmits an operation command for an instruction for imaging to the head-mounted display 12 (S78). The storage unit 67 stores image information of a captured image received from the head-mounted display 12 as the image information 52 in the storage unit 41 (S79).

On the other hand, when the given character is not recognized (NO at S77), the process moves to S80 described below.

The trace recording unit 64 deletes the trace of the axis (S80).

The display control unit 61 determines whether input detection unit 60 detects a given end operation of ending handwriting input (S81). The end operation is, for example, a triple click. When the given end operation is not detected (NO at S81), the process moves to S70 described above. On the other hand, when the end operation is detected (YES at S81), the process ends.

Effect

As described above, the input supporting device 13 according to the first embodiment detects a motion of a finger on which the wearable device 11 is worn. The input supporting device 13 detects an axis representing the posture of the finger on the basis of the detected motion of the finger. The input supporting device 13 displays a virtual laser pointer that moves in association with the detected axis and the trace of the axis on the head-mounted display 12. Accordingly, the input supporting device 13 is capable of supporting input made by using the finger.

The input supporting device 13 according to the first embodiment detects a motion of the finger being bent and stretched. The input supporting device 13 performs calibration on the reference direction of the motion of the finger. Accordingly, even when the wearable device 11 is shifted and worn on the finger, the input supporting device 13 is capable of accurately detecting a motion of the finger.

Furthermore, the input supporting device 13 according to the first embodiment recognizes a character from the trace of the axis. The input supporting device 13 stores the recognized character and the trace in association with each other. Accordingly, the input supporting device 13 is capable of supporting knowing of what is stored as a memo even when a character is erroneously converted upon recognition of the trace.

Furthermore, the input supporting device 13 according to the first embodiment recognizes a character or symbol from the trace of the axis. The input supporting device 13 outputs an operation command to another device on the basis of the recognized character or symbol. Accordingly, the input supporting device 13 is capable of operating another device by using the handwritten character.

### [b] Second Embodiment

The first embodiment of the disclosed device has been explained above; however, the disclosed technology may be carried out in various different modes in addition to the above-described first embodiment. Another embodiment covered by the invention will be explained here.

For example, for the first embodiment, the case has been described where the input system 10 includes the wearable device 11, the head-mounted display 12, and the input supporting device 13. Alternatively, for example, the wearable device 11 or the head-mounted display 12 may have the functions of the input supporting device 13.

For the first embodiment described above, the case has been described where handwriting input is made by using the wearable device 11. Alternatively, for example, a character that is input by handwriting to a touch panel of an information processing device having a touch panel, such as a smartphone or a tablet terminal, may be used. Alternatively, a character that is input by handwriting to a personal computer by using an input device capable of specifying a position, such as a mouse, may be used. Also in this case, easy recognition of a handwritten character is enabled.

Furthermore, for the first embodiment, the case where display is performed on the head-mounted display 12 has been explained. Alternatively, for example, display may be performed on an external display or a touch panel of, for example, a smartphone or a tablet terminal.

Furthermore, for the first embodiment, an operation command for imaging is output to the head-mounted display 12 has been explained. Alternatively, for example, another device may be any device. For example, the input supporting device 13 may store operation commands to various devices in the storage unit 41. The input supporting device 13 may determine a device by image recognition from an image captured by the camera 31 of the head-mounted display 12 and, in accordance with handwriting input, output an operation command to the determined device.

For the first embodiment, the case where correction information is calculated in the calibration mode has been explained. Alternatively, for example, in the calibration mode, a notification indicating that the wearable device 11 is not worn normally may be made to cause the user to cause the wearable device 11 to enter a normal worn state.

For the first embodiment, the case where the recognition unit 66 performs character recognition on a trace determined as a subject to be input from among traces recorded by the trace recording unit 64 has been explained. Alternatively, the recognition unit 66 may perform character recognition after performing various types of filter processing focusing on an event unique to handwriting input by using the wearable device 11.

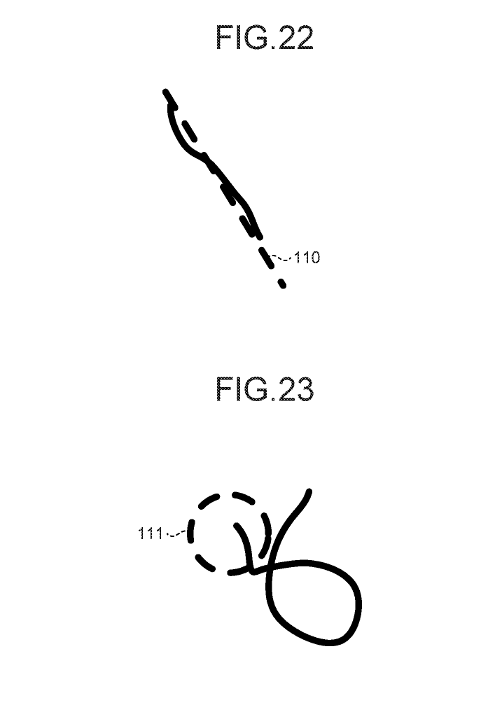

For example, as for handwriting input, even when input is to be made in the upward/downward direction and the leftward/rightward direction, input in which the angle of trace may be shifted with respect to the upward/downward direction or the leftward/rightward direction. Particularly in handwriting input into a free space, because there is no surface into which input is made, a shift tends to occur. For this reason, when it is possible to regard a trace as a line within a given angle with respect to the upward/downward direction or the leftward/rightward direction, character recognition may be performed after the angle correction is performed on the trace. When a straight line connecting the start point and the end point of a trace is within a given angle with respect to the upward/downward direction or the leftward/rightward direction and the trace is within a given width from the straight line, the recognition unit 66 may perform character recognition after correcting the angle of the trace in accordance with the shift in the angle with respect to the upward/downward direction or the leftward/rightward direction. The given angle may be, for example, 30 degrees. The given width may be, for example, one tenth of the distance between the start point and the end point. The given angle and the given width may be set from the outside. The user may be caused to input a trace in the upward/downward direction or the leftward/rightward direction and the recognition unit 66 may detect a shift in the angle of a straight line connecting the start point and the end point from the input trace and detect a width from the straight line of the trace to lean a given angle and a given degree. FIG. 22 is a diagram illustrating exemplary correction on a trace. According to the example illustrated in FIG. 22, the recognition unit 66 performs character recognition by correcting the angle of the trace in accordance with the shift in the angle by which a straight line 110 connecting the start point and the end point of the trace shifts with respect to the upward/downward direction. Accordingly, the input supporting device 13 is capable of accurately performing character recognition on a trace that is input by handwriting.

Furthermore, for example, as for handwriting input by using the wearable device 11, the operation on the switch 20 may be slow or fast. The recognition unit 66 may correct the trace on the basis of the posture variation information before and after the long-press operation on the switch 20 and then perform character recognition. For example, when any one of or both of an abrupt change in the posture and an abrupt change in the acceleration is detected before and after the end of the long-press operation on the switch 20, the recognition unit 66 may perform character recognition excluding the trace part corresponding to the abrupt change. A threshold for detecting the abrupt change may be fixed, or the user may be caused to input a given character by handwriting and a threshold maybe learned from the posture variation information before and after the end of the character. FIG. 23 is a diagram illustrating exemplary correction on a trace. According to the example illustrated in FIG. 23, when a number “6” is input by handwriting, the end of the long-press operation on the switch 20 delays and an abrupt change occurs in an end part 111 of the trace. The recognition unit 66 performs character recognition on the trace excluding the end part 111. The abrupt change in the posture may be detected from a variation in the position sampled at a given cycle during the long-press operation. This enables the input supporting device 13 to perform accurate character recognition on a trace that is input by handwriting.

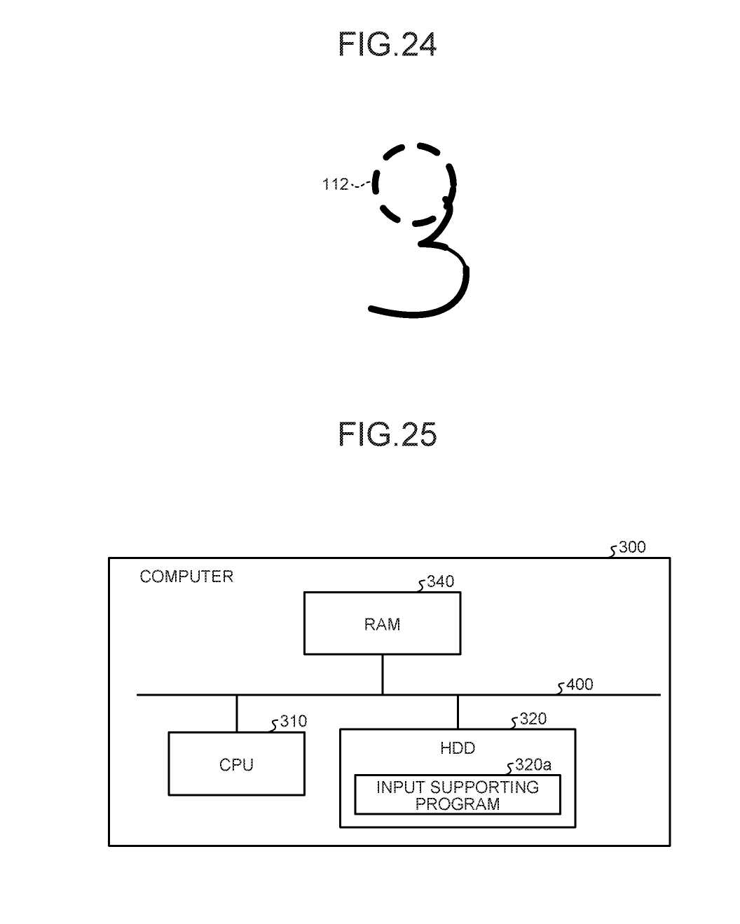

Furthermore, for example, the recognition unit 66 may perform character recognition by performing correction of adding the trace prior to the long-press operation on the switch 20. For example, as a result of the character recognition, when the recognition rate is low or the same posture variation as that appearing when the long-press operation us started has continued before the long-press operation, the recognition unit 66 may perform correction of adding the trace before a given time or the trace from the stop state just before the long-press operation on the switch 20 and then perform character recognition. FIG. 24 is a diagram illustrating exemplary correction on a trace. According to the example illustrated in FIG. 24, a number “3” is input by handwriting, but the long-press operation on the switch 2 delays and thus a first part 112 lacks. The recognition unit 66 performs correction of adding the trace of the part 112 before the long-press operation on the switch 20 and then performs character recognition. Accordingly, the input supporting device 13 is capable of accurately perform character recognition on the trace input by handwriting.

Each component of each device illustrated in the drawings is a functional idea and does not necessarily have to be physically configured as illustrated in the drawings. In other words, a specific mode of dispersion and integration of each device is not limited to that illustrated in the drawings. All or part of the devices may be configured by dispersing or integrating them functionally or physically in accordance with various loads or the usage in an arbitrary unit. For example, the processing units of the input detection unit 60, the display control unit 61, the calibration unit 62, the axis detection unit 63, the trace recording unit 64, the determination unit 65, the recognition unit 66, the storage unit 67, and the operation command output unit 68 may be properly integrated. The processing performed by each processing unit may be separated into processing performed by multiple processing units. Furthermore, all or an arbitrary part of the processing functions implemented by the respective processing units may be implemented by a CPU and by using a program that is analyzed and executed by the CPU, or may be implemented by hard-wired logic.

Input Supporting Program

Various processes explained according to the above-described embodiments may be implemented by executing a prepared program by using a computer system, such as a personal computer or a work station. An exemplary computer system that executes a program having the same functions as those of the above-described embodiments will be explained below. FIG. 25 is a diagram illustrating a computer that executes an input supporting program.

As illustrated in FIG. 25, a computer 300 includes a central processing unit (CPU) 310, a hard disk driver (HDD) 320, and a random access memory (RAM) 340. The units 300 to 340 are connected via a bus 400.

The HDD 320 previously stores an input supporting program 320a that implements the same functions as those of the input detection unit 60, the display control unit 61, the calibration unit 62, the axis detection unit 63, the trace recording unit 64, the determination unit 65, the recognition unit 66, the storage unit 67, and the operation command output unit 68. The input supporting program 320a may be properly separated.

The HDD 320 stores various types of information. For example, the HDD 320 stores an OS and various types of data used to determine an OS and the amount of order.

The CPU 310 reads the input supporting program 320a from the HDD 320 and executes the input supporting program 320a so that the same operations as those of the respective processing units according to the embodiments are implemented. In other words, the input supporting program 320a implements the same operations as those of the input detection unit 60, the display control unit 61, the calibration unit 62, the axis detection unit 63, the trace recording unit 64, the determination unit 65, the recognition unit 66, the storage unit 67, and the operation command output unit 68.

The input supporting program 320a does not necessarily has to be stored in the HDD 32 from the beginning.

For example, the program may be stored in a “portable physical medium”, such as a flexible disk (FD), a CD-ROM, a DVD disk, a magneto-optical disk, or an IC card. The computer 300 may read the program from the portable physical medium and execute the program.

Furthermore, the program may be stored in “another computer (or a server)” that is connected to the computer 300 via a public line, the Internet, a LAN, or a WAN and the computer 300 may read the program from “another computer (or a server)”.

According to an aspect of the present invention, an effect that it is possible to support an input by finger is obtained.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An input supporting method comprising:
detecting, using a processor, a motion of a finger on which a wearable device is worn:
detecting, using the processor, an axis representing a posture of the finger on the basis of the detected motion of the finger; and
displaying, using the processor, a virtual laser pointer that moves in association with the detected axis and a trace of the axis on a head-mounted display.

2. The input supporting method according to claim 1, further comprising:
detecting, using the processor, a motion of the finger caused when the finger is bend and stretched; and
performing, using the processor, calibration on a reference direction of the motion of the finger on the basis of the detected motion of the finger, and wherein
the detecting the axis detects an axis representing the posture of the finger by using the reference direction on which calibration is performed.

3. The input supporting method according to claim 1, further comprising:
recognizing, using the processor, a character from the trace of the axis; and
storing, using the processor, the recognized character and the trace in association with each other.

4. The input supporting method according to claim 1, further comprising:
recognizing, using the processor, a character or symbol from the trace of the axis; and
outputting, using the processor, an operation command to another device on the basis of the recognized character or symbol.

5. A computer-readable recording medium having stored therein a program that causes a computer to execute a process comprising:
detecting a motion of a finger on which a wearable device is worn:
detecting an axis representing a posture of the finger on the basis of the detected motion of the finger; and
displaying a virtual laser pointer that moves in association with the detected axis and a trace of the axis on a head-mounted display.

6. An input supporting device comprising:
a first detection unit that detects a motion of a finger on which a wearable device is worn;
a second detection unit that detects an axis representing a posture of the finger on the basis of the motion of the finger detected by the first detection unit; and
a display control unit that performs control to display a virtual laser pointer that moves in association with the axis detected by the second detection unit and a trace of the axis on a head-mounted display.
